(19) United States
(12) Patent Application Publication
(10) Pub. No.: US 2006/0055500 A1
(43) Pub. Date: Mar. 16, 2006

(54) Encapsulated conductive polymer device and method of manufacturing the same

(75) Inventors: Ray Burke, Whitechurch (IE); Maurice O'Brien, Glanmire (IE); Brian Ahearne, Cork (IE); John Kelly, Passage West (IE)

Correspondence Address: KLEIN, O'NEILL & SINGH, 2 PARK PLAZA, SUITE 510, IRVINE, CA, 92614, US

(73) Assignee: BOURNS, INC, Riverside, CA (US)

(21) Appl. No.: 10/538,220

(22) PCT Filed: Jan. 24, 2003
(86) PCT No.: PCT/US03/02339

§ 371 Date: Jun. 9, 2005

Related U.S. Application Data
(60) Provisional application No. 60/432,552, filed on Dec. 11, 2002.

(51) Int. Cl. H01C 7/13

(52) U.S. Cl. 338/22 R

(57) ABSTRACT

The present invention relates to encapsulated or insulated devices. In certain environments and applications, it is necessary to protect devices from external agents. The present invention achieves this by providing a device comprising a segment of insulating material having an aperture defined therein. An element of active, for example positive temperature coefficient (PTC), material is received within the defined aperture. The element is substantially covered by a first metal layer on one side and a second metal layer on the opposing side. A first layer of insulating material substantially covers the first metal layer and a second layer of insulating material substantially covers the second layer of metal. A first terminal provides an external electrical connection to the first metal layer and a second terminal provides an external electrical connection to the second metal layer. The first terminal is connected to the first metal layer by a conductive interconnect which passes through the first insulating layer and the second terminal is connected to the second metal layer by a conductive interconnect passes through the second insulating layer. Moreover, the invention provides a method for manufacturing devices in a matrix form using conventional PCB techniques to facilitate the mass production of encapsulated devices. Additionally, the resulting components may be used as either leaded or SMT components in either single device or multiple device configurations in both SIP and DIP packages.

The present invention relates to the field of manufacturing electronic components. More specifically, this invention relates to encapsulated or insulated positive temperature coefficient (PTC) devices.

It is well known that the resistivity of many conductive materials changes with temperature. The resistivity of a positive temperature coefficient (“PTC”) material increases as the temperature of the material increases. Examples of such a material are crystalline polymers, made electrically conductive by dispersing conductive fillers therein. These polymers generally include polyolefins such as polyethylene, polypropylene and ethylene/propylene copolymers. Carbon black is an example of a conductive filler.

Typically, a conductive polymer PTC device comprises a layer of conductive polymer PTC material sandwiched between upper and lower metal foil electrodes. The prior art includes single layer devices and multilayer devices, the latter comprising two or more conductive polymer layers separated by one or more internal metal foil electrodes, with external metal foil electrodes on the upper and lower surfaces. Examples of such devices and their methods of manufacture are disclosed in the following U.S. patents, the disclosures of which are incorporated herein by reference: U.S. Pat. 6,429,533; U.S. Pat. No. 6,380,839; U.S. Pat. No. 6,242,997; U.S. Pat. No. 6,236,302; U.S. Pat. No. 6,223,423; U.S. Pat. No. 6,172,591; U.S. Pat. No. 6,124,781; U.S. Pat. No. 6,020,808; and U.S. Pat. No. 5,802,709.

At temperatures below a certain value, referred to generally as the critical or switching temperature, PTC materials of the type referred to above exhibit a relatively low, constant resistivity. However, as the temperature of the PTC material increases beyond this point, the resistivity of the material sharply increases with temperature. When the temperature of the material cools down below the critical or switching temperature, the resistivity reverts to its low, constant value.

This effect has been used in the production of electronic PTC devices providing overcurrent protection in electrical circuits, where they are generally placed in series with a load. Under normal operating conditions, the resistance of the load and the PTC device is such that a relatively small current flows in the PTC device. Under these conditions the temperature of the device due to ohmic heating remains below the critical or switching temperature of the PTC device. If, however, the load is short circuited or the circuit experiences a power surge, the current flowing through the PTC device increases and the temperature of the PTC device rises rapidly due to ohmic heating. As the PTC device reaches its critical temperature, a significant amount of power is dissipated in the PTC device. Typically, this power dissipation occurs only for a fraction of a second, but the increased power dissipation raises the temperature of the PTC device to a value where the resistance of the PTC device becomes so high that the current in the circuit is limited to a relatively low value. This limited current value is enough to maintain the PTC device at a high temperature/high resistance equilibrium point, but is suitably designed to prevent damage to other electrical circuit components. Thus, the PTC device performs the function of a fuse, reducing the current flow through the short circuit load to a safe, relatively low value when the temperature of the PTC device reaches or exceeds the critical temperature.

In order to allow the PTC device to cool down below its critical temperature and return to its normal operating, low resistance state, it is necessary to switch off the power or remove the fault condition responsible for the short circuit. Thus PTC devices of this type may be seen to operate as resettable electrical circuit protection devices.

Chu et al (U.S. Pat. No. 6,377,467) discloses a surface mount PTC device. The construction of the Chu device however suffers from a number of disadvantages including a limited effective area for the PTC material, and manufacturing difficulties arising from the provision of electrical connections to the laminar electrodes of the PTC material by interconnects passing adjacent to the electrodes.

McGuire et al (U.S. Pat. No. 5,907,272) and McGuire (U.S. Pat. No. 5,884,391) disclose a surface mount PTC device, which offers reliable connections to the laminar electrodes. It is suggested however that the manufacturing methods of these patents maybe inefficient and costly. Moreover, in certain environments and applications, it is necessary to protect the PTC device from external agents. The disclosed device leaves PTC material exposed to such agents. An example of such an environment is the use of PTC devices in battery straps. Battery straps are used to provide a protection circuit within a battery housing to prevent damage to the battery.

Typically, battery straps comprise a PTC device having two leads (straps) soldered, or otherwise fixed to its terminals. These leads are used to provide device connections. In lithium battery applications, lithium salts or other electrolytes may leak on to the PTC device and damage the PTC material. Accordingly, it is necessary to protect the PTC device. One known way of providing protection is to wrap the PTC device in a protective tape. However, this is a costly and time consuming process. In addition, PTC devices are prone to damage from mechanical mishandling.

Another disadvantage of existing PTC devices is that the creepage distance between the two terminals is effectively the thickness of the PTC material. In certain environments, for example batteries, this distance may be bridged by contaminants such as swarf or battery salts rendering the PTC device ineffectual.

Accordingly, there is a need for an improved PTC device and method for manufacturing same.

### SUMMARY OF THE INVENTION

Accordingly, in a first aspect the present invention provides an encapsulated electronic device comprising an element of electronically active material sandwiched between a first laminar electrode and a second laminar electrode. A region of insulating material encloses the first laminar electrode, the second laminar electrode and the element of active material. A first terminal is provided for facilitating an external electrical connection to the first laminar electrode and a second terminal is provided for facilitating an external electrical connection to the second laminar electrode. The first terminal and the first laminar electrode are connected by a first conductive interconnection that passes through the region of insulating material. A second conductive interconnection that passes through the region of insulating material electrically connects the second terminal and the second laminar electrode. At least one of the interconnections comprises a metal plating.

By encapsulating the active material and laminar electrodes within a region of insulating material, the active material is protected from external agents. The use of a metal plating to provide the interconnections between the electrode and terminal facilitates the manufacture of the devices using standard PCB processing techniques. Suitably, the first conductive interconnection and the second conductive interconnections are both provided by a metal plating.

The electronic device may be a leaded device having a first lead affixed to its first terminal and a second lead is affixed to its second terminal. A third terminal may be provided on the same side of the device as the first terminal and electrically connected to the second terminal by a first electrical connection formed between opposing sides of the device through said region of insulating material. The first electrical connection may be a plated through hole via. The resulting device may be a leaded device having a first lead affixed to said first terminal and a second lead affixed to said third terminal. Alternatively, the device may be a surface mountable device with the first and third terminals providing surface mount technology (SMT) connections. A fourth terminal may be provided on the same side of the device as the second terminal and electrically connected to the first terminal by a second electrical connection formed between opposing sides of the device through said region of insulating material. This second electrical connection may be a plated through hole via.

The region of insulating material may include a first layer of insulating material separating said first laminar electrode and said first terminal and/or a second layer of insulating material separating said second laminar electrode from said second terminal. The region of insulating material may comprise a printed circuit board material having an aperture defined therein in which said element of active material is received. Suitably, the active material is a positive temperature coefficient material, optionally a polymeric material.

In another aspect of the invention, an encapsulated PTC device is provided comprising a segment of insulating material having an aperture defined therein. An element of PTC material is received within the defined aperture. A first surface of the PTC element is covered by a first laminar electrode and a second surface of the PTC element is covered by a second laminar electrode. The first electrode is substantially covered by a first layer of insulating material and the second electrode is substantially covered by a second layer of insulating material. A first terminal for providing an external electrical connection to the first electrode is provided on top of the first layer of insulation and a second terminal is provided on the second layer of insulation for providing an external electrical connection to the second electrode. The first terminal is connected to the first electrode by a first conductive interconnection that passes through the first insulating layer and the second terminal is connected to the second electrode by a second conductive interconnection that passes through the second insulating layer.

The resulting encapsulated device has a structure which protects the PTC material from external agents and which may be manufactured using low cost printed circuit board manufacturing techniques. The first and second layers of insulating material may be provided as layers of resin. Suitably, the segment of insulating material comprises circuit board material. Optionally the circuit board material is a laminate structure of glass or aramid fibers bonded with a resin material. Alternatively, the first and second insulating layers may provide the segment of insulating material.

The encapsulated PTC device may be a leaded device with leads fixed to the first and second terminals. Moreover, the encapsulated device, when leaded, is particularly suitable as a battery strap.

A third terminal may be provided that is electrically connected to the second terminal by a first conductive interconnection that passes through the insulating segment. Leads may be fixed to the first and third terminals to produce a reduced height leaded encapsulated PTC device. This is particularly suitable for use as a battery strap. The first conductive interconnection that passes through the insulating segment may be a plated through hole via.

Additionally, a fourth terminal may be provided that is electrically connected to the first terminal by a second conductive interconnection that passes through the insulating segment. The second conductive interconnection that passes through the insulating segment may comprise a plated through hole via. The first, second, third and fourth terminals may be suitably disposed to provide a symmetrical device. The terminals of the device may be metal plated. Optionally, the metal plating is a combination of copper, nickel and/or gold. Moreover, the plating may comprise three separate metal plates of copper, nickel and gold.

In yet another aspect of the invention, a method of manufacturing an electronic device is provided. The method comprises the step of providing an element of electronically active material having a first metal layer as a first laminar electrode and a second metal layer as a second laminar electrode. The first laminar electrode, the second laminar electrode and the element of electronically active material are surrounded with a region of insulating material. A first terminal for facilitating an external electrical connection to the first laminar electrode and a second terminal for facilitating an external electrical connection to the second laminar electrode are provided. A first opening is created through the region of insulating material and a conductive path provided therein to electrically connect the first terminal and the first laminar electrode. Similarly, a second opening is created through the region of insulating material and a conductive path provided therein to electrically connect the second terminal and the second laminar electrode.

The step of surrounding the first laminar electrode, the second laminar electrode and the segment of electronically active material with a region of insulating material may comprise the steps of placing the element of active material into an aperture defined in a printed circuit board material. Leads may be fixed to the first terminal and to the second terminal.

The method may comprise the additional step of providing a third terminal on the same side of the device as the first terminal, and electrically connecting the third terminal to the second terminal using a first electrical connection formed between opposing sides of the device through said region of insulating material. The step of electrically connecting the third terminal to the second terminal may be performed by metal plating. Leads may be affixed to the first terminal and the third terminal.

The method may comprise the additional steps of providing a fourth terminal located on the same side of the device as the second terminal, and electrically connecting the fourth terminal to the first terminal using a second electrical connection formed between opposing sides of the device through said region of insulating material.

The step of electrically connecting the fourth terminal to the first terminal is implemented by metal plating. The step of surrounding the first laminar electrode, the second laminar electrode and the segment of electronically active material with a region of insulating material, may comprise the step of covering said first laminar electrode with a first layer of insulating material and/or the step of covering said second laminar electrode with a second layer of insulating material.

The active material may be a positive temperature coefficient material, optionally a polymeric material.

A further aspect of the invention, is a method of manufacturing an encapsulated PTC device comprising the steps of surrounding the perimeter of an element of PTC material with a segment of insulating material, providing said element of PTC material with a first laminar electrode substantially covering a first major surface of the PTC element, providing said element of PTC material with a second laminar electrode substantially covering a second major surface of the PTC element, forming a first layer of insulating material substantially covering the first electrode, forming a second layer of insulating material substantially covering the second electrode, providing a first terminal for facilitating an external electrical connection to the first laminar electrode, providing a second terminal for facilitating an external electrical connection to the second electrode, forming an electrical connection between the first terminal and the first electrode through said first insulating layer, and forming an electrical connection between the second terminal and the second electrode through said second insulating layer.

The segment of insulating material may comprise a circuit board material, optionally a laminate structure of glass or aramid fibers bonded with a resin material. The first and second layers of insulating material may be provided as layers of resin.

The step of surrounding the circumference of an element of PTC material with a segment of insulating material may be performed using the first and second insulating layers. The method may include the step of fixing leads to the first and second terminals. A third terminal may be provided electrically connected to the second terminal by the formation of a first conductive interconnection that passes through the insulating segment. Leads may be fixed to the first and third terminals. A metal plating process may be used to form the first conductive interconnection that passes through the insulating segment.

The method may include providing a fourth terminal and electrically connecting it to the first terminal by forming a second conductive interconnection that passes through the insulating segment. A metal plating process may be used to provide the first conductive interconnection that passes through the insulating segment.

The method may position the first, second, third and fourth terminals to provide a symmetrical device. The terminals may be plated using a metal plating process. Another aspect of the invention is a method of manufacturing a paralleled device comprising the steps of supplying a first matrix comprising a plurality of devices, each device in the first matrix comprising at least one element of electronically active material sandwiched between two laminar electrodes, wherein a terminal is provided for each of the two electrodes on both sides of the first matrix; depositing a conductive fixing material on the terminals on the top surface of the matrix; and, placing a second matrix comprising a plurality of devices, each device in the second matrix comprising at least one element of electronically active material sandwiched between two laminar electrodes, wherein a terminal is provided for each of the two electrodes on at least the underside of the matrix, such that the arrangement of terminals on the top surface of the first matrix aligns with the arrangement of terminals on the bottom surface of the second matrix, resulting in a combined matrix of paralleled devices.

The use of this method facilitates the concurrent production of a significant number of paralleled devices, which otherwise would have to be produced individually. The method may comprise the further step of singulating paralleled devices from the combined matrix. The electronically active material may be a PTC material, optionally a polymeric PTC-material.

In yet another aspect of the invention, a matrix of devices is provided wherein each device comprises a first laminar electrode, a second laminar electrode, a segment of electronically active material sandwiched between said first laminar electrode and said second laminar electrode, a first terminal for facilitating a connection to the first laminar electrode, a second terminal for facilitating a connection to the second laminar electrode, a first layer of insulating material separating the first terminal from the first laminar electrode, and a second layer of insulating material separating the second terminal from the second laminar electrode, wherein adjacent elements of electronically active material are separated from each other by a region of insulating material.

The region of insulating material may be a section of PCB material having apertures or pockets defined therein for receiving the elements of electronically active material. Alternatively, the region of insulating material comprises the first layer of insulating material and said second layer of insulating material. The electrical interconnections may be provided between the first terminal and the first electrode by at least one plated blind via passing through the first layer of insulating material. The electrical interconnections between the second terminal and the second electrode suitably may be provided by at least one plated blind via passing through the second layer of insulating material. Each device in the matrix may have a third terminal located on the same surface of the matrix as the first terminal and electrically connected to the second terminal by a first electrical connection formed between opposing surfaces of the matrix through said region of insulating material by a plated through hole via. The individual devices of the matrix may be configured as surface mountable devices said first and third terminals providing SMT connections. A fourth terminal for each device may be located on the same surface of the matrix as the second terminal and electrically connected to the first terminal by a second electrical connection formed between opposing surfaces of the device through said region of insulating material by a plated through hole via. The active material in the matrix may be a positive temperature coefficient material, optionally a polymeric material, or it may be a dielectric material, a resistive material, a magnetic material, or a semiconductor material. A shared region of metal may provide the terminals of adjacent devices in the matrix.

The invention also provides for a component singulated from the matrix. The component may be configured as a SIP component, in which the first and second terminals of each device are aligned along one edge of the device. The first terminal in the component device may be connected to an underlying third terminal by means of a first plated through-hole connection through the region of insulating material. The second terminal in the component device may be connected to an underlying fourth terminal by means of a second plated through hole connection passing through the region of insulating material. Alternatively, the component may be configured as a DIP component. The component may be a leaded device with a suitable lead frame attached to the first and second terminals. The component may include two or more devices. One or more of the devices in the component may be a PTC device, optionally of the conductive polymer type. The component may be adapted to have one or more circuit protection devices or components of another type mounted thereon, such as, for example, a thyristor, a metal oxide varistor, and/or a gas discharge tube.

The above-mentioned advantages of the present invention, as well as others, will be more readily appreciated from the detailed description that follows.

### BRIEF DESCRIPTION OF THE DRAWINGS

FIG. 1 is a perspective view of a PTC element comprising a segment of PTC material laminated between two metal layers, which is used in the construction of a PTC device according to the invention;

FIG. 2 is a perspective view of a individual section of a board having an aperture formed therein for receipt of the section of PTC material of FIG. 1, the individual section being shown for the purpose of illustrating the steps in the method of fabricating a PTC device in accordance with the present invention;

FIG. 3 is a perspective view of a board comprising a plurality of individual sections of the type shown in FIG. 2 with a PTC element of the type shown in FIG. 1.

FIG. 4 is a cross sectional view of an arrangement comprising the section of board of FIG. 2, taken along line X-X of FIG. 2, into which the PTC element of FIG. 1 has been placed;

FIG. 5 is a cross sectional view of the arrangement of FIG. 4 illustrating a step in the process of the invention;

FIG. 6 is a cross sectional view of the arrangement of FIG. 5 illustrating a further step in the process of the invention;

FIG. 7 is a cross sectional view of the arrangement of FIG. 6 illustrating a further step in the process of the invention;

FIG. 8 is a cross sectional view of the arrangement of FIG. 7 illustrating a further step in the process of the invention;

FIG. 9 is a cross sectional view of the arrangement of FIG. 8 illustrating a further step in the process of the invention;

FIG. 10 is a cross sectional view of the arrangement of FIG. 9 adapted for use as a leaded/strap device,

FIG. 11 is a cross sectional view of the arrangement FIG. 6 illustrating a step in the process of the invention for the production of a second embodiment of the invention;

FIG. 12 is a cross sectional view of the arrangement of FIG. 11 illustrating a further step in the process of the invention;

FIG. 13 is a cross sectional view of the arrangement of FIG. 12 illustrating a further step in the process of the invention;

FIG. 14 is a cross sectional view of the arrangement of FIG. 13 illustrating a further step in the process of the invention;

FIG. 15 is a cross sectional view of the arrangement of FIG. 14 adapted for use as a leaded/strap device,

FIG. 16 is a cross sectional view of the arrangement of FIG. 11 illustrating a first step in an alternative method to FIG. 12;

FIG. 17 is a cross sectional view of a symmetrical embodiment of the device;

FIG. 18 is a plan view of a matrix of devices of the type shown in FIG. 17,

FIG. 19 is a plan view of an individual device singulated from the matrix of FIG. 18,

FIG. 20 is a plan view of an embodiment of the invention comprising four individual devices singulated from the matrix of FIG. 18 as a single component,

FIG. 21 is a plan view of a SIP embodiment of the invention comprising four individual devices,

FIG. 22 is an end view of the SIP embodiment of FIG. 21 with a lead frame attached,

FIG. 23 is a plan view of a second SIP embodiment of the invention comprising four individual devices,

FIG. 24 is a plan view of a third SIP embodiment of the invention comprising an individual device,

FIG. 25 is a schematic representation of a line protection circuit suitable for implementation by devices of the invention,

FIG. 26 is a plan view of an implementation of the schematic circuit of FIG. 25 according to the invention,

FIG. 27 is a side view of a matrix of devices as shown in FIG. 18,

FIG. 28 is a side view of the matrix of FIG. 27 illustrating a further step in a process of the invention,

FIG. 29 is a side view of the matrix of FIG. 28 illustrating a further step in a process of the invention, and

FIG. 30 is a side view of a singulated device formed from the matrix of FIG. 29.

### DETAILED DESCRIPTION OF THE DRAWINGS

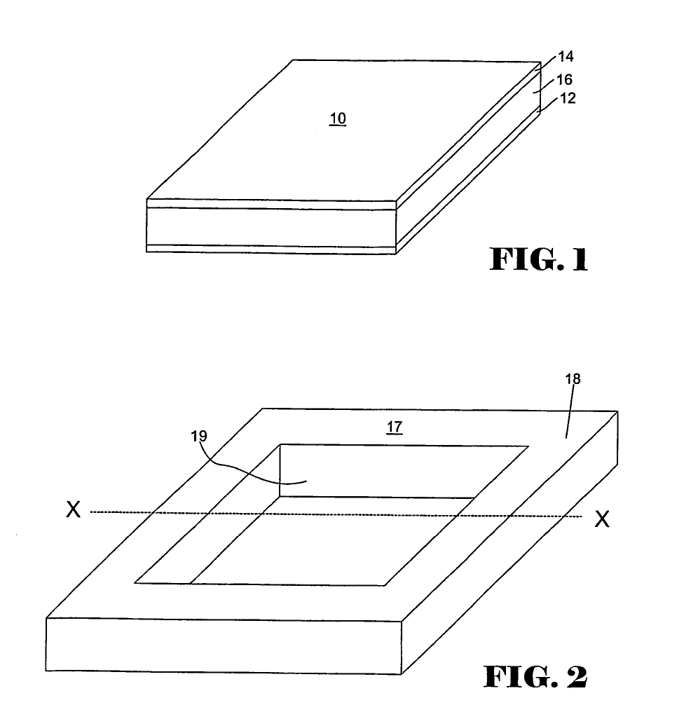

Referring now to the drawings, FIG. 1 illustrates a laminated segment 10, comprising a layer 16 of electronically active material, (e.g., a conductive polymer PTC material) sandwiched between a first or lower metal layer 12 and a second or upper metal layer 14 that may be provided as an initial step in the process of manufacturing an electronic device in accordance with the present invention. In the context of the present invention, electronically active material is intended to identify a material that may perform an active role in a circuit. Examples of such materials would include, but are not intended to be limited to, dielectric, resistive, magnetic (e.g. ferrite) and semiconductor materials. The first and second metal layers 12, 14 function as laminar electrodes for the sandwiched active material 16. The segment 10 may be singulated from a larger laminated sheet. The invention will now be described in greater detail as an embodiment in which the electronic device is a circuit protection device and the material is a conductive polymer PTC material.

The conductive PTC material may be made of any suitable PTC material, including for example suitable conductive polymer compositions. An example of a suitable conductive polymer composition would be high density polyethylene (HDPE) into which is mixed an amount of carbon black that results in the desired electrical operating characteristics. An example of such a mixture is disclosed in WO97/06660, the disclosure of which is incorporated herein by reference The metal layers may comprise any suitable metal foils, with copper being preferred, although other metals, such as nickel and aluminum and a number of alloys are also acceptable. In a specific preferred embodiment, a copper foil is used that has an inner surface that is formed with a micro-textured surface (a “nodularized” surface). The nodularized surface is plated with a very thin passivation layer of nickel, preserving the micro-textured surface profile for improved adhesion to a conductive polymer layer sandwiched between the foil layers.

A laminated sheet, from which a plurality of individual PTC segments 10 may be singulated, may be fabricated by any of several suitable processes that are well known in the art, as exemplified by the above referenced publication WO97/0660. Suitable techniques for singulation are well known in the art and include routing, guillotining, dicing, punching, laser cutting and scoring.

A segment 18 of a board 17, as illustrated in FIG. 2, is provided having an aperture 19 defined therein. The aperture 19 is suitably dimensioned to receive the PTC element 10 of FIG. 1. The board may be fabricated from any suitable insulating material, but is preferably a board of the type used in printed circuit board manufacture. An example of such a board is a laminate comprising layers of glass or other fiber impregnated with a suitable plastic material, for example epoxy resin. A suitable glass-filled epoxy resin material is described generally in the art as FR4 board.

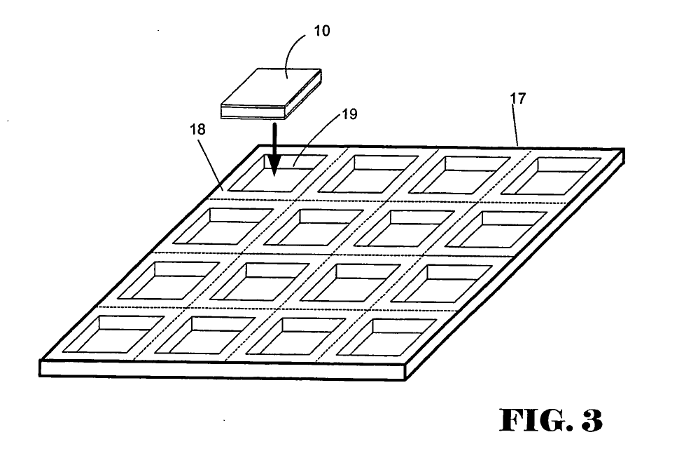

In practice, the board 17 may be suitably dimensioned and arranged, as shown in FIG. 3, to facilitate the concurrent production of a matrix comprising a plurality of devices. The dashed lines in FIG. 3 only serve to identify individual sections 18 of the board 17 as shown in FIG. 2. A plurality of apertures 19 are provided in the board, with each aperture dimensioned to receive a corresponding segment of PTC material 10, thus making it possible to manufacture a plurality of PTC devices concurrently in a matrix. For example, an 18×24 inch (46×61 cm) board may be used to produce a matrix of approximately 15,000 PTC circuit protection devices. It will be appreciated that the ability to manufacture such a large number of devices concurrently using conventional processes available from the low cost printed circuit board industry result in components having a very low unit cost. The manufacture of the devices in a matrix form also facilitates the production of individual protection components comprising two or more PTC devices. The apertures in the board may be created using any suitable technique, including for example routing, stamping and punching. For ease of explanation, the remaining steps of the process will be described with reference to a section 18 of the board 17 having a single aperture 19 defined or shaped to receive a corresponding laminated segment 10. However, it will be appreciated that the subsequent process steps are intended to be performed on a board having a plurality of apertures, and that the individual board section 18 is only shown for ease of explanation.

The process begins, as shown in FIG. 4, with the placing of the laminated segment 10 within the aperture defined in the section 18 of board 17 of FIG. 2. The segment 10 may have metal layers 12, 14 attached on opposing sides of the PTC material 16 as illustrated in FIG. 1. As an alternative to commencing with a PTC element having a laminar structure of PTC material and metal foils, a segment of PTC material (without foils) may be placed within the aperture 19 defined in the board and metal foils placed on top and underneath the board as part of the manufacturing process. This method of applying laminar electrodes to the PTC material may be more cost effective and effective than applying the laminar electrodes as part of an extrusion process when producing a sheet of PTC material. To prevent shorting, arising from subsequent steps in the process, the metal foils placed on the top and bottom may be etched to provide a suitable electrode pattern.

To ensure that individual segments 10 may be placed with ease within the apertures 19 defined in the board section 18, the apertures are dimensioned to be slightly larger than the corresponding laminated segments 10. For example, if the segment is about 14 mm long and 4 mm wide in size, the aperture might be dimensioned to provide a spacing of approximately 20 microns around the segment when positioned in the aperture.

It is intended that the thickness of the segments 10 is substantially the same as the thickness of the board. However, an exact match is not essential and appropriate thicknesses may be selected for convenience. For example, a typical thickness for a Printed Circuit Board (PCB) would be 300 microns, whereas a typical thickness for the laminated segment might be in the range of 260 microns to 280 microns.

Although the segments may be placed within the apertures using a manual technique, i.e. hand placing, there are a number of techniques which are more suitable to mass production, for example, pick and place machines or shaking tables.

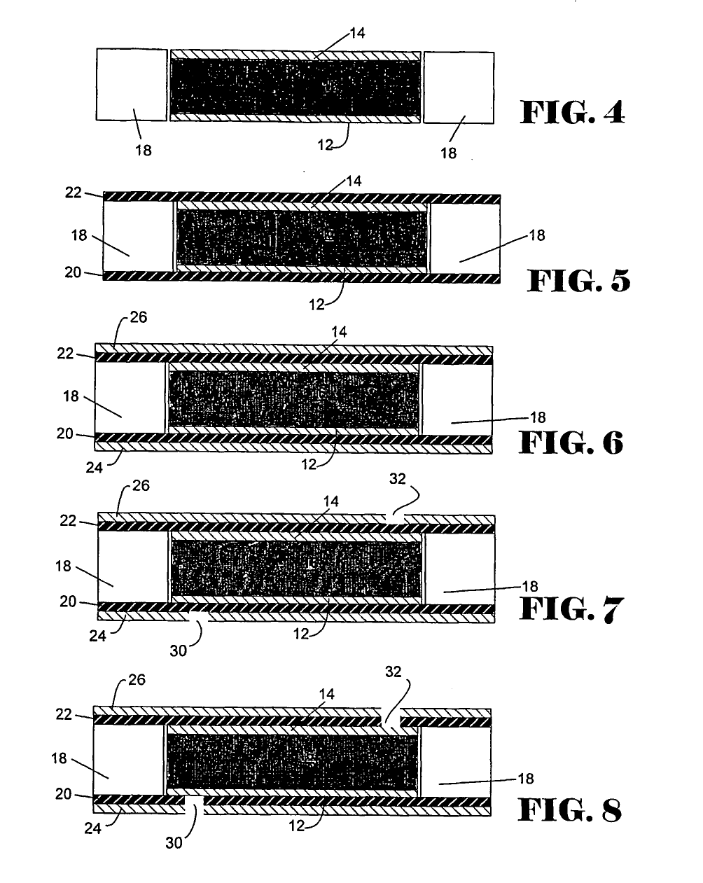

To retain the PTC element 10 within the aperture 19 of the board section 18, a first layer of insulating material 20 is provided to cover the first layer 12 of metal and the bottom surface of the board section 18, as shown in FIG. 5. Similarly, a second layer 22 of insulating material is provided to cover the second layer 14 of metal and the opposing (top) surface of the board section 18. The first and second layers of insulating material 20, 22 co-operate with the board section 18 to effectively encapsulate the PTC segment. In practice, the board may be placed on the first layer of insulating material prior to placement of the PTC elements within the apertures.

Exemplary insulating materials would include plastic (e.g. epoxy resin). Fibers (e.g. glass) may be included within the insulating material to provide mechanical strength.

Although the above method steps have been described with reference to the use of a board having a plurality of pre-defined apertures for receiving elements of active material, alternative methods may be used to effectively encapsulate the PTC segment. Moreover, configurations are possible in which the PTC segment itself defines and is used to form the aperture in which it is effectively encapsulated. In one exemplary alternative method, a first layer of insulating, e.g. pre-preg, material is placed on a surface. Advantageously, the first layer of insulating material may be combined with a metal layer [e.g. using a resin coated copper (RCC) material] the advantage of which will be appreciated from the description below. Individual PTC segments, comprising a layer of PTC material sandwiched between two metal electrodes, may then be placed on top of the layer of insulating material, for example using a pick and place machine or other suitable technique. A second layer of insulating material (advantageously RCC material) may then be laid on top of the first layer of insulating material and PTC segments. The resulting structure may be placed in a laminating press or similar device. The heat and pressures of the lamination press will cause the first and second insulating layers to join and effectively encapsulate the PTC segments, resulting in a structure equivalent to that shown in FIG. 5, in which the PTC segment is encapsulated by a top insulating layer 22, a bottom insulating layer 20 and enclosed by a region equivalent to the board section material 18, but which is provided in effect by a combination of the first and second insulation layers 20, 22. It will be appreciated, that the thickness of the layers of insulating material used in this alternative technique may need to be thicker than in the alternative techniques illustrated with respect to FIG. 1 to 3. Other methods, including the placing of PTC devices on a surface and the dispensing or spraying of insulating material or the moulding of insulating material around the PTC devices, may also be used to provide a matrix of encapsulated PTC elements. Moreover, the process of providing a matrix of devices having a region of insulating material around each device may be performed using a combination of techniques and the region of insulating material may be the result of several different steps of applying insulating material and is not intended to be limited to the specific methods described herein.

Reverting to the main method and referring to FIG. 6, a third layer 24 of metal is provided on the first layer 20 of insulating material, for example by laying a metal foil on top of the insulating material. Similarly, a fourth layer 26 of metal is provided on the second layer 22 of insulating material, for example by placing a metal foil underneath the second insulating layer 20. This results in the structure shown in FIG. 6. Suitable metals for the metal layers include copper, nickel, aluminium, and a number of alloys thereof. The third and fourth layers of metal 24, 26 will ultimately provide first and second terminals respectively for facilitating electrical connections to the PTC device. As an alternative, the metal layers may be provided using a plating or other deposition process.

Advantageously, the steps of applying a layer of insulating material and providing a metal layer may be combined into a single step using a resin clad metal material, for example RCC. The use of RCC allows the metal and insulating layers to be applied concurrently. A suitable RCC material would be a 1080 glass fabric impregnated with approximately 62% resin content and clad with a thickness of copper of about 18 microns. The adherence of the insulating layers to the first and second metal layers 12, 14 and to the third and fourth metal layers 24, 26 may be achieved by conventional PCB techniques including the use of a lamination press in a multi layer PCB technique familiar to those skilled in the art. It is believed that an advantage of using a laminating press is that during the lamination process, heat developed will cause the PTC material to expand, as it would during a short circuit fault. When the device cools after lamination, the contracting PTC material will cause a flexing of the insulating material in a controlled matter. It is believed that this self-tripping of the PTC material during the lamination process improves the ultimate performance of the device. It will be appreciated that the order of assembly described above is not essential and that the alternative orders may be used, for example the process may start with a sheet of RCC material onto which the board having apertures defined therein may be placed. The PTC elements may then be placed into the apertures and then the board covered with a further sheet of RCC material.

The resulting device structure after lamination, as shown in FIG. 6, effectively provides a fully encapsulated PTC element, which is totally enclosed within insulating material. Moreover the first and second layers of insulating material 20, 22, acting in combination with the board section 18, provide an insulating barrier surrounding the PTC segment.

To obtain a device that functions as a PTC device requires the provision of electrical connections to the laminar electrodes (first and second metal layers) 12, 14 of the PTC element through the insulating barrier 18, 20, 22. Moreover, it is necessary to provide electrical interconnections between the first and third metal layers 12, 24 through the first insulating layer 20 and between the second and fourth metal layers 14, 26 through the second insulating layer 22.

Before an electrical connection between the first and third metal layers 12, 24 may be established, an opening is required from the lower surface of the sheet (third metal layer 24) through to the surface of the first metal layer 12. Suitable methods for forming such an opening include laser drilling and etching.

One etching technique which is particularly suitable is a two step etching process in which the first step is a conventional photo resist and etching process, familiar to those skilled in the art, which selectively removes metal from the third metal layer 24, in areas 30 where an electrical interconnection is required, the result of which is illustrated in FIG. 7. A second step in the process uses a chemical etch, which is suitably selected to selectively etch insulating material but not metal. In this second etching process, the third metal layer acts as a mask to prevent removal of the insulating material in regions other than that of the opening 30 defined by the first etching step. The second etching step extends the opening 30 through the first insulating layer 20. The etching process halts when it reaches the underlying first metal layer 12. Thus, as illustrated in FIG. 8, a first path or “micro-via” 30 is opened by etching through the third metal layer 24 and the first layer of insulating material 20 to the first metal layer 12. The micro-via may be considered as a blind micro-via as it does not pass through from the top surface to the bottom surface of the device.

Similarly, as shown in FIGS. 7 and 8, a two step etching process may be used to form a second path or micro-via 32 in the top surface of the device, through the fourth metal layer 26 in a first etching step, and in a second step through the second insulating layer 22 to the underlying laminar electrode provided by the second metal layer 14.

Once the micro-vias 30, 32 have been formed, conductive electrical interconnections may be provided through them by disposing conductive material within the micro-vias. One method of providing the conductive interconnection is plating. The electrical connections may also be provided by inserting a conductive material, for example conductive epoxy or solder paste, into the micro-vias 30, 32. Using a suitable plating process, as shown in FIG. 9, a lower plating layer 42 and an upper plating layer 44 may be deposited on intended areas of the surface of the sheet, including building up along the walls of the micro-vias 30, 32. In practice, the plating process may combine a number of individual processing steps, for example an etch resist layer (not shown) may first be deposited (e.g. by printing) on areas where metal plating is not desired. An electroless plating process may then be used to provide a thin (seed) plated layer (not shown) upon areas not covered by the etch resist layer. The thickness of this seed layer of metal plating may be increased using a subsequent electrolytic plating process. Typically, the etch resist material is then removed. Thus, as shown in FIG. 9, a first electrical interconnection 46 is provided between the first metal layer 12 and the third metal layer 24, and a second electrical interconnection 48 is provided between the second metal layer 14 and the fourth metal layer 26.

The electroless plating process may be a copper based electroless plating system. If copper plating is used, however, further plating steps may be advantageously employed to passivate the copper and thus prevent or minimize migration. In particular, an electroless nickel plating process may be used to passivate the copper. In a nickel electroless plating process, nickel will only form a plating on exposed areas of copper. To provide a final terminal surface suitable for soldering and other processes, a final electroless plating process may be used to provide a gold plating on exposed areas of plated nickel.

The resulting structure provides a PTC device in which the PTC material 16 is insulated by the surrounding board section 18 in combination with the first and second layers of insulating material 20, 22 that cover the laminar electrodes 12, 14 of the segment 10. Electrical connections to the resulting device are available from the top and bottom terminals 42, 44 (plated third and fourth metal layers respectively) which are electrically connected to the underlying laminar electrodes 12, 14, respectively, by the first and second interconnections 46, 48, respectively, that are formed within the micro-vias 30, 32, as described above.

As the device is effectively protected by the insulating material, less care is required in the packaging of the individual devices, resulting in lower packaging and handling costs.

To facilitate the use of the device in particular electronic applications, first and second leads 50, 52 may be attached to the device, as shown in FIG. 10. These leads may be soldered, or otherwise affixed, directly to the plated top and bottom terminals 42, 44. In a battery strap application, these leads typically comprise flexible metal straps, made of, for example, a high purity nickel of approximately 0.127 mm thickness.

In certain applications where there is limited headroom, the height of components is a critical issue. In the case of battery strap applications, where the PTC device is intended to be housed within the housing of the battery, any reduction in height is desirable as the battery tends to occupy a significant space within modern electronic devices, e.g. mobile phones, and any reduction in this space is important to reduce the overall size of electronic devices.

In a further embodiment of the invention, a device is provided, as illustrated in FIG. 15, which has a reduced height. This reduction in height is achieved by the placement of two terminals 64, 66 and two device leads 70, 72 on the same side of the device.

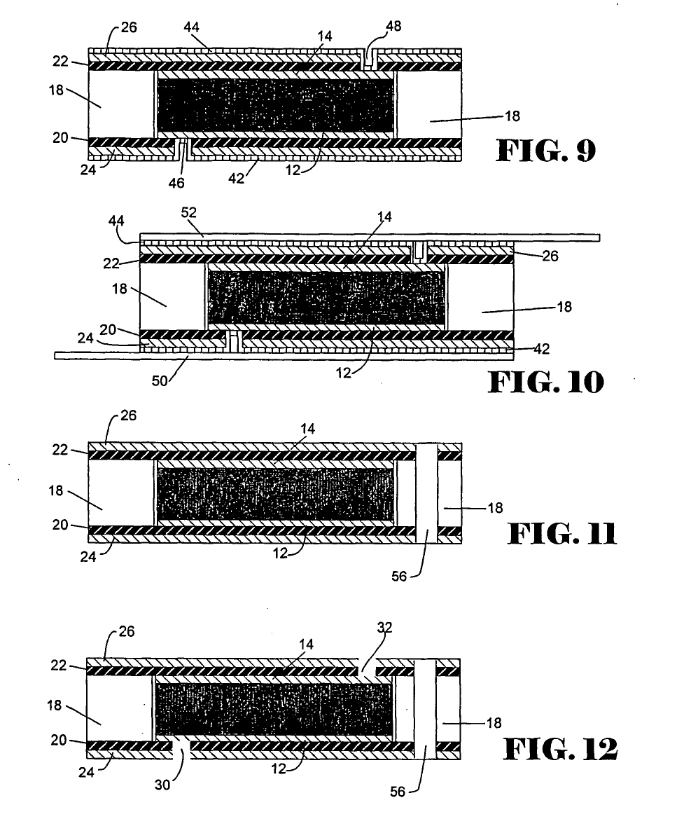

In order to place the leads 70, 72 on the same side of the device, it is necessary to provide an electrical connection 60 between the opposing sides of the PTC device. The provision of this electrical connection will now be described with reference to FIG. 11 which corresponds directly to the structure of FIG. 6 with the provision of an additional aperture (through hole via) 56 which passes from the top surface of the laminated board structure through to the bottom surface of the laminated board structure, without contacting the PTC material 16, i.e. through the fourth metal layer 26, the second insulating layer 22, the board section 18, the first insulating layer 20, and the third metal layer 24. This aperture 56 may be formed using any suitable process including etching, drilling, laser drilling and punching.

Once the aperture 56 has been formed, an electrical connection 60 may be established through this aperture 56 between the third metal layer 24 and fourth metal layer 26, as shown in FIG. 14. As the aperture 56 does not pass through the PTC segment 16, the electrical connection 60 is effectively insulated from the PTC segment.

The electrical connection 60 may be provided at the same time as providing the first electrical interconnection 46 between the first and third metal layers and the second electrical interconnection 48 between the second and forth metal layers, or in a separate process.

Thus, for example the electrical connection 60 may be provided by the same process described above or a separate plating process, or by the insertion of solder paste or other conductive material within the aperture 56.

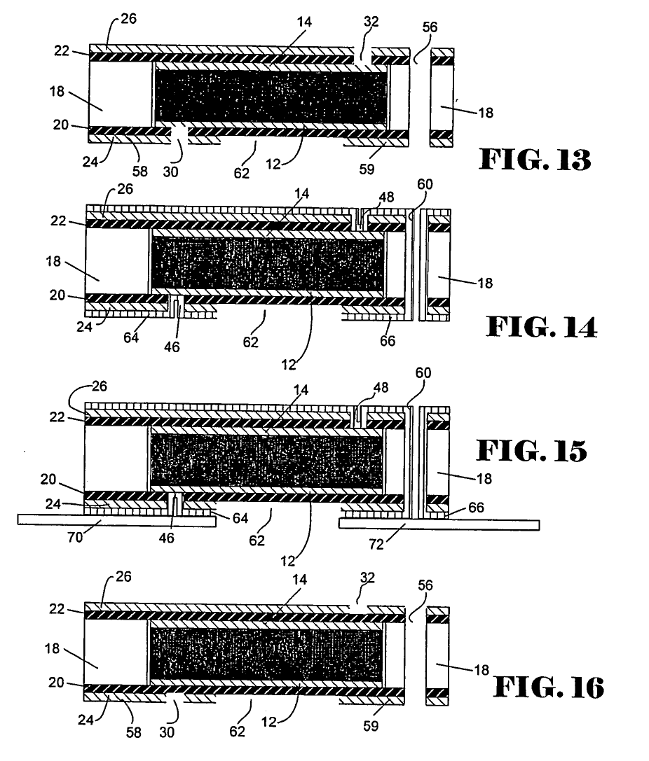

In order to facilitate connections to the bottom surface of the resultant device, metal may be selectively removed from the third metal layer (for example, by etching), to provide two separate terminals 64, 66 separated by a region 62 where metal has been removed, as shown in FIG. 14. This selective removal of metal may be performed after the provision of the electrical connection between the third and fourth layers or more advantageously before the plating process as illustrated in FIG. 12, FIG. 13, and FIG. 14. With respect to FIG. 12, a two step etching process, as described above with respect to FIG. 7 and FIG. 8 may be used to selectively remove metal from the third metal layer and insulating material in areas 30 where an electrical interconnection is required so as to open a first path or “micro-via” 30. Similarly, a two step etching process may be used to form a second path or micro-via 32 in the top surface of the device, through the fourth metal layer 26 in a first etching step, and in a second step through the second insulating layer 22 to the second metal layer 14.

Once the openings 30,32 for the micro-vias have been formed, a region of metal may be selectively removed from the third metal layer (for example, by etching), to provide two separate regions 58, 59 for terminals separated by a region 62 where metal has been removed, as shown in FIG. 13. A plating process, as described above, may be used to provide electrical connections through the micro-vias, and to provide a protective plating on the resulting terminals 64, 66. Moreover, an electroless plating process may be used to provide a thin (seed) plated layer upon areas not covered by a previously applied etch resist layer. The thickness of the metal plating may then be increased using an electrolytic plating process. Conventionally, the previously applied etch resist material may then be removed.

An alternative method of forming the electrical connections to that of the method described above with reference to FIGS. 12 and 13 which advantageously uses one less etching step, commencing from the structure of FIG. 11, uses an etching process to provide an opening 30 by selectively removing metal from the third metal layer 24, in areas 30 where an electrical interconnection is required. In the same etching process, a region of metal is selectively removed from the third metal layer 24 to define two separate regions for subsequent use as terminals 58, 59 separated by a region 62 where metal has been removed. Similarly, as shown in FIG. 16 an etching process may be used to provide an opening by selectively removing metal from the fourth metal layer 26, in areas 32 where an electrical interconnection is required. Further steps are used to extend the openings/blind via 30, 32 through the insulating layers 20,22 to the underlying laminar electrodes 12,14. However, to ensure that the insulating material is not removed from the region separating the terminal regions, a laser drilling or similar process is used in place of the chemical etch previously described to extend the micro-vias through to the underlying laminar electrodes 12,14. This results in the same structure as illustrated in FIG. 13 effectively using one less etching process compared to the previously described method as the formation of terminals 64,66 and the initial opening of the micro-via 30,32 are performed concurrently.

As described above, plating or other processes may be used to provide electrical connections through the micro-vias (effectively to form plated micro-vias), connections through the aperture 56 from the top surface to the bottom surface and to provide a protective conductive coating on the terminals.

The resulting structure, as shown in FIG. 14, comprises a PTC device in which the terminals 64, 66 that provide electrical connections to the device are on the bottom surface of the device. Thus the device may be used directly in surface mount applications. Moreover, the device may be used to provide a leaded PTC device as shown in FIG. 15 in which the leads 70, 72 are fixed to the terminals 64,66 on the same side of the device, thus providing a height saving equivalent to the thickness of one lead when fixed to the device. This is particularly advantageous in battery strap applications. The leads may be fixed for example by soldering or conductive glue.

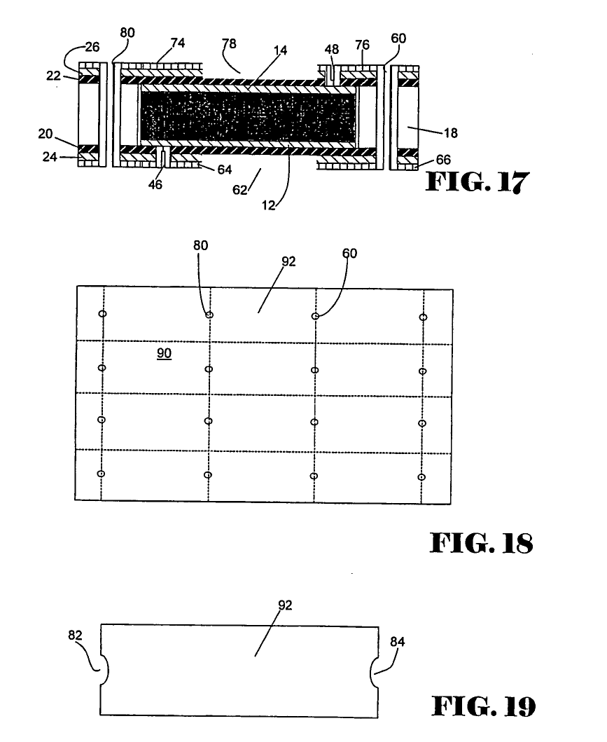

The device illustrated in FIG. 14 is non-symmetrical in the sense that the device may only be placed on board (when used as an SMT device), right way up, or the two leads may only be attached on one side. A further embodiment, as illustrated in FIG. 17, provides for a symmetrical device. To provide a symmetrical device, a second electrical connection 80 is required between the top and bottom surfaces of the device. In the exemplary symmetrical device shown, a second aperture or through hole via is provided from the fourth metal layer 26 through to the third metal layer 24, through the first insulating layer 20, the board section 18 and the second insulating layer 22. This second via may be provided in the same manner, in fact using the same processes, as the previously prescribed via 56 of FIG. 11. Once the via has been created, an electrical connection may be formed through the via aperture between the top and bottom surfaces of the device, for example using the plating process previously described to produce a plated through hole via 80.

To provide a symmetrical device, the bottom layer is divided into two terminals 64, 66 as previously described, and similarly the top layer of the device (plated fourth metal layer) is divided into two terminals 74, 76, for example by means of a conventional photo resist and etching technique using the methods described previously in respect of the division of the bottom layer to define two terminals.

This results in a structure, as shown in FIG. 17, in which four terminals 64, 66, 74, 76 are provided for connecting to the PTC device. As paired terminals 64,74; 66,76 are provided on opposing surfaces of the device, the resulting structure provides an encapsulated symmetrical PTC device. In particular, a first terminal 64 provides an electrical connection to the first laminar electrode 12 of the PTC device via the first plated interconnection 46 through the third metal layer 24 and the first insulating layer 20. A second terminal 76 provides an electrical connection to the second laminar electrode 14 of the PTC device via the second plated interconnection 48 through the fourth metal layer 26 and the second insulating layer 22. The third terminal 66 is connected to the second terminal 76 by a plated interconnection (through hole via) 60 through the first insulating layer 20, the board section 18, and the second insulating layer 22. The fourth terminal 74 is connected to the first terminal 64 by the plated interconnection 80, which passes through the first insulating layer 20, board section 18 and the second insulating layer 22. The first and third terminals 64, 66 are separated from each other by a region 62 where the third metal layer 24 has been selectively removed. Similarly, the second and fourth terminals 74, 76 are separated from each other by a region 78 where the fourth metal layer 26 has selectively been removed by an etching process. Advantageously, the etching step may also be employed to provide device marking by etching out appropriate patterns in regions of the top and/or bottom metal layers not functionally required.

As explained above, a plurality of devices are intended to be constructed in a single matrix 90 as shown in FIG. 18. In practice the matrix will comprise a significantly larger number of devices. It is sometimes desirable that electrical connections be available to the side of devices. The matrix 90 of PTC devices 92 facilitates this possibility as devices 92 may be singulated along lines defined by the plated apertures 60, 80 (as shown in dashed outline) thus resulting in the structure shown in FIG. 19 in which electrical connections may be made directly to the resulting plated channels 84, 82, corresponding to the effectively dissected plated apertures 60, 80, disposed on opposing ends of the device.

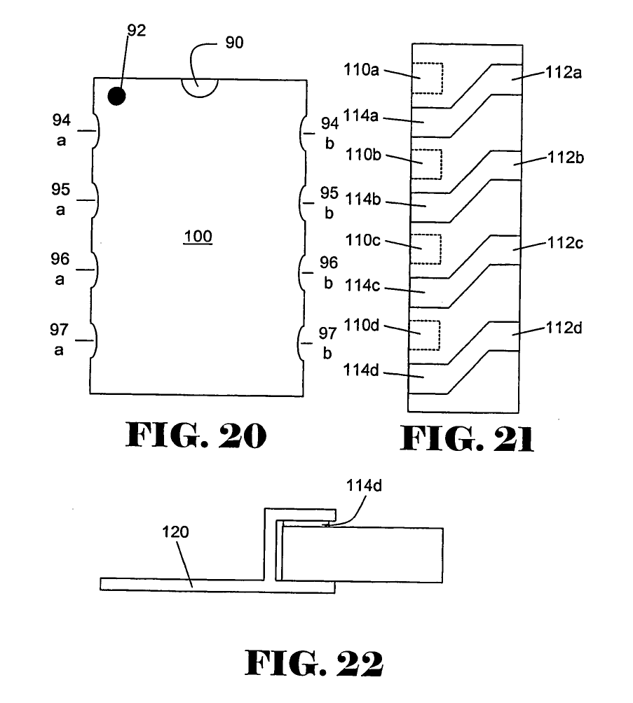

The embodiment of FIG. 19 may be adapted to provide a multi-PTC device, as illustrated in FIG. 20. This multi-PTC device presents a plurality of the PTC devices, of the type illustrated in FIG. 14, which are fabricated in a matrix using the processes described above. During the singulation process, a group of the PTC devices are singulated as an array 100. The exemplary array 100 shown comprises four individual PTC devices, although the exact number of devices can be altered depending on circumstances. Each of the individual PTC devices in the array has pairs of terminals 94a, 94b; 95a, 95b; 96a, 96b; 97a, 97b in the form of plated channels on opposing sides of the device 100 to which electrical connections may be made. It will be appreciated, that the third and fourth metal layers will need to be etched or otherwise processed during manufacture to isolate adjoining PTC devices in the array from each other. The array may readily be structured or configured to resemble an integrated circuit structure for subsequent use by pick and place machines. Apart from appropriately dimensioning the array and positioning the plated channels to represent appropriate IC sizing and connections, additional features may be included during the manufacturing process. For example, a notch 90 may be provided in the top center of the array to identify the position of the top of the device. Similarly, a small dot 92 may be provided in the top left hand corner of the array to identify the top left hand corner of the resulting device. These additional features may be provided using conventional PCB techniques including etching as integral steps within the manufacture of the matrix described above before singulation.

The resulting IC type device may be readily modified for use as a dual in-line package (DIP) by appropriate fixing of a lead frame.

Although DIP packages are popular, in circumstances where board space is at a premium, single in-line packages (SIP) are preferred. The present invention may be readily adopted for use as a SIP package by providing paired terminals for connecting to each PTC device along one side of the array rather than on opposing sides of the device. An exemplary arrangement for a SIP package is shown in FIG. 21, in which a matrix of four devices of the exemplary structure shown in FIG. 9, where the terminals for providing connections are disposed on opposing sides of the device, is provided. The dashed outlines represent the terminals 110a, 110b, 110c, 110d on the underside of the device. In this exemplary structure, the metal layers providing the terminals have been suitably etched or otherwise processed to produce the terminal configurations shown. In effect paired terminals for each of each devices are provided along a single edge of the array device. The paired terminals 110a, 114a; 110b, 114b; 110c, 114c; 110d, 114d for each device are on opposing surfaces. Using an appropriate lead frame, leads 120 may be connected which provide a connection to both sides, as shown in FIG. 22, thus obviating the requirement for providing electrical interconnections from the top surface of the device through to the bottom surface of the device. The second terminals 114a, 114b, 114c, 114d of each pair of terminals for the device are respectively connected by tracks 115a, 115b, 115c, 115d to the region 112a, 112b, 112c, 112d respectively in the top metal layer where the blind micro-vias have been used to provide a connection to the underlying laminar electrode of each device. It will be appreciated that these tracks may be formed in the same etching process that defines the terminals.

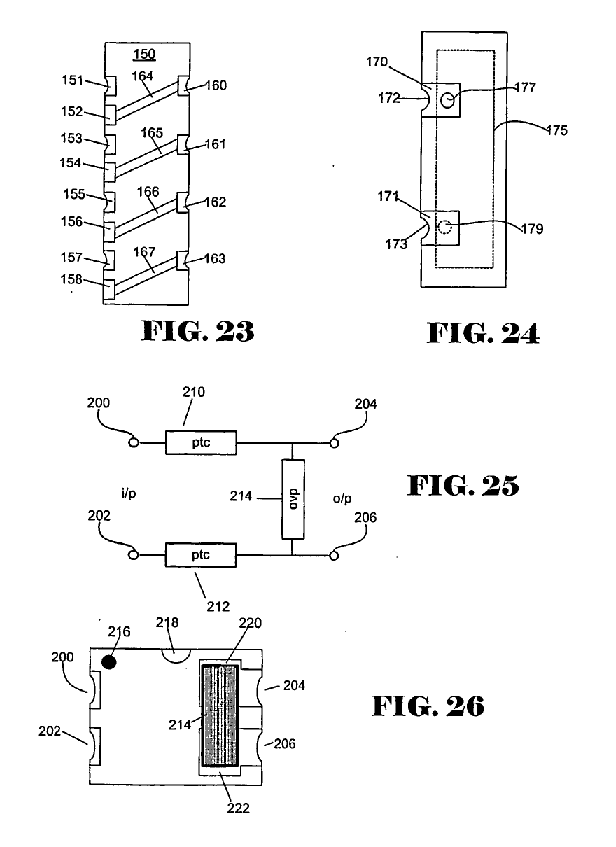

Although, this exemplary SIP package is suitable for use with a lead frame that attaches to both the top and bottom surfaces of a device, it is not suitable for use in situations where the leads of the lead frame are attached to a single surface of the device. In these situations, it is necessary to provide a connection between the terminals on opposing surfaces of the device as was described with reference to the use of the plated through hole 60 of FIG. 14 to provide a SMT component. An exemplary construction is the electronic protection component shown in FIG. 23, which illustrates a quad PTC device 150 having terminals 151, 152, 153, 154, 155, 156, 157, 158 for connection to a single sided lead frame aligned along an edge of the device. Plated through hole vias 160, 161, 162, 163 (along which the devices are singulated) provide the connections between the top and bottom surfaces and associated tracks 164,165,166, 167 provide connections between the opposite edges of the device as was previously described with reference to FIG. 21.

A drawback of the embodiment of FIG. 23 is that tracks are required to provide a connection between the two sides of the device. An improved embodiment, as shown in FIG. 24, provides the terminals along the same edge of the device without the need for tracks. In particular, the device has two terminals 170, 171, with each terminal connecting to a laminar electrode of a PTC device encapsulated within the device. The two terminals 170, 171 are arranged along the same device edge. Plated through hole connections 172,173 (formed prior to singulation from a matrix structure described above) provide connections between the top and bottom surfaces of the terminals. As described previously, the through hole connections 172,173 pass through a region of insulating material and do not make contact with the embedded PTC material 175 (shown for illustration by means of dashed outline in FIG. 24). One of the terminals 170 connects with a laminar electrode by means of a blind micro via 177 (previously described) on the top surface of the device, whereas the other terminal 171 connects with the remaining laminar electrode by means of a blind micro via 179 (shown also in dashed outline) on the bottom surface of the device. The resulting component is a SIP device suitable for use as an SMT component where the terminals function as SMT connections. Alternatively, the component may be used as a leaded device by attachment of a lead frame. In either case, the component is not limited to single devices and it will be appreciated that a SIP device may be manufactured having a plurality of PTC devices encapsulated therein, with each device having two terminals disposed along an edge of the component. Moreover, it will be appreciated that the exact number of PTC devices for a particular component is decided by the number of PTC devices grouped together as a single component during singulation of the matrix described above.

Depending on the application, the individual characteristics of the PTC devices of the multi-PTC device (e.g. SIPs, and DIPs) may be equivalent or different. Different characteristics may be achieved by having differently sized PTC segment areas and correspondingly sized apertures in the board for receiving each of the individual PTC segments.

As the PTC devices described herein are manufactured using conventional PCB techniques, the resulting devices may be used as miniature printed circuit boards onto which further circuit protection devices, for example a battery charge controller or over voltage protection devices including gas discharge tubes, thyristors or metal oxide varistors (MOV) may be fixed, for example by direct soldering to the terminals, to provide a circuit protection module. For example, the exemplary differential line protection circuit shown in FIG. 25 comprising two PTC devices 210,212, providing over current protection, each in series with a separate incoming line 200,202, followed by an over voltage protection device 214, for example a metal oxide varistor (MOV), thyristor or gas discharge tube (GDT), in parallel with the outputs 204,206 may be manufactured by singulating a DIP package from the previously described matrix to provide two PTC devices, with each of the PTC devices having an input terminal 200,202 on one side of the device and an output terminal 204,206 on the opposing side of the device. The top surface of the singulated device is suitably configured, as shown in FIG. 26, such that the output terminals on the top surface of the device are dimensioned to act as pads 220, 222 for receiving the voltage protection device 214. The voltage protection device 214 may be pick and placed onto the pads 220,224 and fixed in place using a suitable means, for example either using pre-placed solder paste (which may be then reflowed) or a conductive epoxy. The resulting device may be used as an SMT line protection device, with the terminals underlying the device (or plated channels\notches) at the sides providing SMT connection points. Additionally, as described above, suitable device markings may be included to aid orientation of the device. For example, a notch 218 may be provided in the top center of the array to identify the position of the top of the device. Similarly, a small dot 216 may be provided in the top left hand corner of the array to identify the top left band corner of the resulting device. Although, the exemplary protection circuit has been shown as a 4 pin DIP SMT component, it is not limited to this configuration. Moreover, the size of the overall component will be limited by the minimum size of protection device required\available for a particular application.

A drawback of existing PTC devices is that the effective area of the PTC material limits the trip currents of the devices. However, as circuit board space is generally at a premium, designers are reluctant to use devices having large device footprints. One solution to this problem is the previously described SIP packages. Another, known solution is to provide PTC devices in a parallel configuration using a multilayer device construction. However, these known constructions are overly complex in their manufacture.

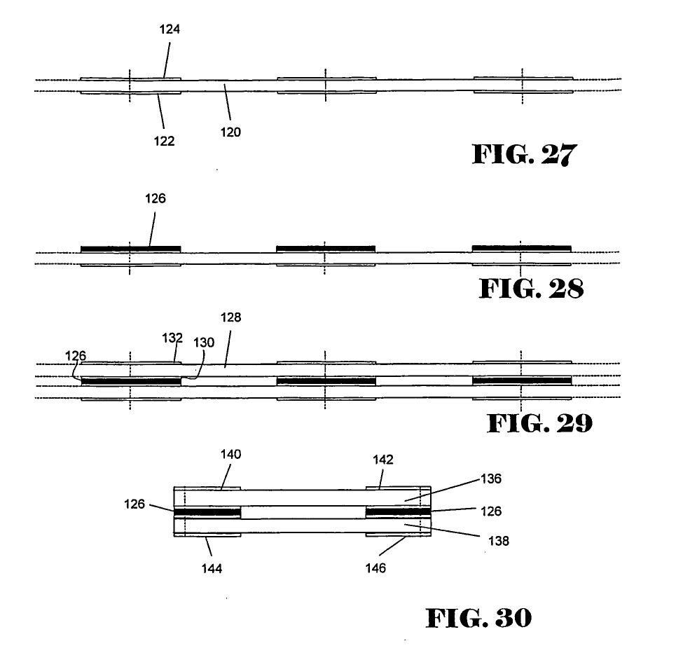

The matrix construction of the present invention facilitates a simple and efficient method of providing two or more devices in parallel in a quasi-multilayer construction. A side view of a section of a matrix of devices (of the symmetrical type shown in FIG. 17) is illustrated in FIG. 27 (the internal construction of the device is not shown for ease of explanation, with the vertical dashed lines representing points along which devices would be singulated equating to the locations of the through connections 60,80 of FIG. 17). Each of the individual devices of the matrix has four terminals defined to provide device symmetry when singulated. The method commences with the placing of a first matrix of devices 120 in a suitable jig or fixture (not shown). Solder paste 126 or other conductive fixing material (e.g. conductive glue) is applied to the terminal areas 124 on the top surface of the matrix as shown in FIG. 28. A second matrix of devices 128 having a matching arrangement of terminals areas 130 on its underside is then placed on top of the first matrix as shown in FIG. 29. In the case of using solder paste, the entire arrangement is then placed in a reflow oven to cause the solder paste to flow. When cooled the, the two matrices are held together in a double-decked or duplicate matrix structure by the solder material, which electrically connects the terminals areas of the two matrix. It will be appreciated that when the resulting duplex matrix is singulated, the singulated devices, as shown in FIG. 26, are in effect two devices 136, 138 connected in parallel with the terminals 140, 142 on the upper surface of the top device providing one pair of terminals and the terminals on the lower surface of the bottom device providing a corresponding pair of terminals 144, 146 on the bottom surface. Each of the top terminals 140, 142 is electrically connected to its respective bottom terminal 144,146 by respective plated channels (as described previously and shown in dashed outline in FIG. 30) in cooperation with the solder material 126. This method of manufacturing devices in parallel is not limited to the use of two matrices, several matrices may be joined concurrently. However, as the number of matrices increases, practical difficulties arise in causing the solder paste to reflow correctly. This difficulty may be overcome if a conductive epoxy or other material is used in place of the solder paste.

Although, the present invention has been described with reference to an active material of the PTC type, it will be appreciated that the manufacturing process of the present invention may be advantageously applied to other active polymer materials and PTC materials and also to other materials including dielectrics, resistive, magnetic and semiconductor materials.

1. An encapsulated electronic device, comprising;
a first laminar electrode,
a second laminar electrode,
an element of electronically active material sandwiched between said first laminar electrode and said second laminar electrode,
a region of insulating material enclosing said first laminar electrode said second laminar electrode and said element of active material, wherein said region of insulating material comprises a first layer of insulating material covering the first laminar electrode and a second layer of insulating material covering the second laminar electrode
a first terminal for facilitating an external electrical connection to the first laminar electrode,
a second terminal for facilitating an external electrical connection to the second laminar electrode,
a first conductive interconnection that passes through the of first layer of insulating material to electrically connect the first terminal and the first laminar electrode,
a second conductive interconnection that passes through the of second layer of insulating material to electrically connect the second terminal and the second laminar electrode, and
further comprising a third terminal located on the same side of the device as the first terminal and electrically connected to the second terminal by a first electrical connection formed between opposing sides of the device through said region of insulating material such that the first electrical connection is insulated from the element of active material.

2. An encapsulated electronic device according to claim 1, wherein said first conductive interconnections and second conductive interconnections both comprise metal plating.

3. An encapsulated electronic device according to claim 1, wherein said electronic device is a leaded device having a first lead affixed to said first terminal and a second lead is affixed to said second terminal.

4. (canceled)

5. An encapsulated electronic device according to claim 1, wherein said first electrical connection comprises a plated through hole via.

6. An encapsulated electronic device according to claim 1, wherein said device is a leaded device having a first lead affixed to said first terminal and a second lead affixed to said third terminal.

7. An encapsulated electronic device according to claim 1, wherein said device is a surface mountable device and said first and third terminals provide SMT connections.

8. An encapsulated electronic device according to claim 1, wherein said device comprises a fourth terminal located on the same side of the device as the second terminal and electrically connected to the first terminal by a second electrical connection formed between opposing sides of the device through said region of insulating material.

9. An encapsulated electronic device according to claim 8, wherein said second electrical connection comprises a plated through hole via.

10-11. (canceled)

12. An encapsulated electronic device according to claim 1, wherein said region of insulating material comprises a printed circuit board material having an aperture defined therein in which said element of active material is received.

13. An encapsulated electronic device according to claim 1, wherein said active material is a positive temperature coefficient material.

14. An encapsulated electronic device according to claim 13, wherein said positive temperature coefficient material is a polymeric material.

15-16. (canceled)

17. An encapsulated electronic device according to claim 12, wherein the circuit board material is a laminate structure of glass or aramid fibers bonded with a resin material.

18. An encapsulated electronic device according to claim 1, wherein the first and second layers of insulating material are provided as layers of resin.

19. (canceled)

20. An encapsulated electronic device according to claim 1, wherein said device is a leaded device and wherein leads are fixed to the first and third terminals.

21. A battery strap comprising at least one encapsulated electronic device according to claim 20.

22-27. (canceled)

28. An encapsulated electronic device according to claim 8, wherein the first, second, third and fourth terminals are suitably disposed to provide a symmetrical device.

29. An encapsulated electronic device according to claim 28, wherein the terminals are metal plated.

30. An encapsulated electronic device according to claim 29 wherein the metal plating is a combination of copper, nickel and/or gold.

31. An encapsulated electronic device according to claim 30 wherein the plating comprises three separate metal plates of copper, nickel and gold.

32. A method of manufacturing an electronic device, comprising the steps of:
(a) providing an element of electronically active material having a first metal layer as a first laminar electrode and a second metal layer as a second laminar electrode, (b) surrounding the first laminar electrode, the second laminar electrode and the element of electronically active material with a region of insulating material,
(c) providing a first terminal for facilitating an external electrical connection to the first laminar electrode, said step comprising the steps of covering said first laminar electrode with a first layer of insulating material and covering said second laminar electrode with a second layer of insulating material,
(d) providing a second terminal for facilitating an external electrical connection to the second laminar electrode,
(e) creating a first opening through the region of insulating material,
(f) providing a conductive path in said first opening to electrically connect the first terminal and the first laminar electrode,
(g) creating a second opening through the region of insulating material,
(h) providing a conductive path in said second opening to electrically connect the second terminal and the second laminar electrode and
(i) providing a third terminal on the same side of the device as the first terminal and electrically connecting the third terminal to the second terminal using a first electrical connection formed between opposing sides of the device through said region of insulating material.

33. A method of manufacturing an electronic device according to claim 32, wherein said step of surrounding the first laminar electrode, the second laminar electrode and the segment of electronically active material with a region of insulating material comprises the steps of placing the element of active material into an aperture defined in a printed circuit board material.

34. A method of manufacturing an electronic device according to claim 32, comprising the additional steps of fixing a first lead affixed to said first terminal and a second lead to the second terminal.

35. (canceled)

36. A method of manufacturing an electronic device according to claim 32, wherein said step of electrically connecting the third terminal to the second terminal is implemented by metal plating.

37. A method of manufacturing an electronic device according to claim 32, comprising the additional steps of fixing a first lead affixed to said first terminal and a second lead to the third terminal.

38. A method of manufacturing an electronic device according to claim 32, comprising the additional steps of:
providing a fourth terminal located on the same side of the device to the second terminal,
and electrically connecting the fourth terminal to the first terminal using a second electrical connection formed between opposing sides of the device through said region of insulating material.

39. A method of manufacturing an electronic device according to claim 38, wherein said step of electrically connecting the fourth terminal to the first terminal using is implemented by metal plating.

40-41. (canceled)

42. A method of manufacturing an electronic device according to claim 32, wherein said active material is a positive temperature coefficient material.

43. A method of manufacturing an electronic device according to claim 42, wherein said positive temperature coefficient material is a polymeric material.

44. A method of manufacturing an electronic device according to claim 32, wherein the step of surrounding the first laminar electrode the second laminar electrode and the element of electronically active material with a region of insulating material comprises the step of surrounding the circumference of an the element of electronically active material with a segment of insulating material.

45. A method of manufacturing an electronic device according to claim 44, wherein the segment of insulating material comprises circuit board material.

46. A method of manufacturing an electronic device according to claim 45, wherein the circuit board material is a laminate structure of glass or aramid fibers bonded with a resin material.

47. A method of manufacturing an electronic device according to claim 32, wherein the first and second layers of insulating material are provided as layers of resin.

48-54. (canceled)

55. A method of manufacturing an electronic device according to claim 38, wherein the first, second, third and fourth terminals are positioned to provide a symmetrical device.

56-88. (canceled)
